(19) United States
(12) Patent Application Publication
(10) Pub. No.: US 2010/0057809 A1
(43) Pub. Date: Mar. 4, 2010

(54) INFORMATION STORING/RETRIEVING METHOD AND DEVICE FOR STATE TRANSITION TABLE, AND PROGRAM

(76) Inventor: Kiyohisa Ichino, Minato-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 12/513,088

(22) PCT Filed: Oct. 24, 2007
(86) PCT No.: PCT/JP2007/070739

§ 371 Date: Apr. 30, 2009

(30) Foreign Application Priority Data
Nov. 1, 2006 (JP) 2006-298088

(51) Int. Cl. G06F 17/30

(52) U.S. Cl. 707/752; 707/E17.033

(57) ABSTRACT

Information storing/retrieving method for a state transition table includes: in a state transition table wherein transition destinations are made to correspond to states and inputs, collecting inputs, which have same transition destination and whose values are contiguous, into one set to configure the inputs as sets; sorting the sets so that sets, which share the same transition destination, become adjacent; storing input lower- or upper-limit values and non-duplicate transition destination(s), included in sorted sets, into a memory in the sorted order to reduce information amount of the state transition table; when one state and one input are given, referencing memory to retrieve lower- or upper-limit value and a transition destination of a set(s) corresponding to the state and comparing the retrieved lower- or upper-limit value with the input value to identify a set, to which given input belongs, based on comparison; and retrieving a transition destination from the identified set for determining transition destination as a next state.

### TECHNICAL FIELD

### Related Application

The present application claims priority from prior Japanese patent application 2006-298088 (filed on Nov. 1, 2006) the content of which is hereby incorporated in its entirety by reference into this specification.

The present invention relates to a finite state machine, and more particularly to a method, a device, and a program for storing information into, and retrieving information from, a state transition table.

### BACKGROUND ART

A Finite State Machine (also called a finite-state machine or a finite automaton) is applied to an extremely wide variety of fields including not only sequence circuits in machine control or electronic circuits but also in calculation models, information search, and text editing in a computer. FIG. 1 is a diagram showing a generalized representation of a finite state machine. When an input 2, supplied from the external world of a finite state machine 1, and a state 14 are determined, the state transition table stored in a state transition memory 11 is referenced and a transition destination 12 is determined as the next state. Next, an output table 13 is referenced to obtain an output 3 corresponding to the transition destination. The output is applied to the external world and, as a result, a new input is given to the finite state machine 1 and the content of the state 14 becomes the next transition destination 12.

FIG. 2 is a diagram showing a state transition table in the simplest representation form. This state transition table describes the transition destinations (A-a, . . . D-e, . . . ) for all combinations of multiple inputs (a, b, c, d, e, . . . ) and multiple states (A, B, C, D, . . . ). The information amount of the state transition table is directly proportional to the product of the number of values taken by the inputs and the number of states. For this reason, if the range of values taken by the inputs is wide or if the number of states is large, the state transition memory 11 becomes a large capacity, and the cost, power consumption, and installation dimension efficiencies are decreased. To solve this problem, many studies have been carried out on the method for representing a state transition table in a small amount of information. One of those conventional technologies is a method, called a double-array method (Non-Patent Document 1), that represents a state transition table using double-arrays.

As shown in FIGS. 11(a) and 11(b), the double-array method uses the state transition diagram used to check for a match, for example, in the three patterns “ABC”, “CA”, and “CC”, the state transition table, and the array table that indicates the content of two one-dimensional arrays named BASE and CHECK. Using the property that the state transition table in FIG. 11(c) contains many elements for which the transition destination 12 is not defined, the double-array method moves the rows of the state transition table in FIG. 11(c) horizontally and rearranges them so that the number of elements, for which the transition destination 12 is not defined, is reduced. When the state transition table in FIG. 11(c) contains the state(s) and input(i), the algorithm for determining the transition destination(t) is as follows.

Transition destination(t)=BASE(state(s))+Input(i)

Note that, if CHECK(BASE(state(s))+Input(i)) is equal to the state(s), the state transition succeeds and the transition destination(t) is defined; if not, the state transition fails and the transition destination(t) is not defined.

Using a specific BASE array and a CHECK array, the following shows how the input text “ABC” is accepted. Note that the internal representation values (numeric values) of the characters A, B, and C are 1, 2, and 3, respectively.

First, the initial value of the state(s) is 1 and

(1) Because the first character of the text is A, input(i)=A=1.
(2) The array table in FIG. 11(b) indicates that BASE(1)=1.
(3) Therefore, transition destination(t)=BASE(1)+1=2.
(4) Because the array table in FIG. 11(b) indicates that CHECK(2)=1 and, at the same time, the state(s)=1, this transition succeeds. The state transition diagram indicates that a transition occurs from state 1 to state 2 as indicated by the transition label A.

Next, when state(s)=2 as a result of the above transition, the transition occurs as follows.

(1) Because the second character of the text is B, input(i)=B=2.
(2) The array table in FIG. 11(b) indicates that BASE(2)=4.
(3) Therefore, transition destination(t)=BASE(2)+2=6.
(4) Because the array table in FIG. 11(b) indicates that CHECK(6)=2=state(s), this transition succeeds. The state transition diagram in FIG. 11(a) indicates that a transition occurs from state 2 to state 6 as indicated by the transition label B.

Finally, when state(s)=6, the transition occurs as follows.

(1) Because the third character of the text is C, input(i)=C=3.
(2) The array table in FIG. 11(b) indicates that BASE(6)=4.
(3) Therefore, transition destination(t)=BASE(6)+3=7.
(4) Because the array table in FIG. 11(b) indicates that CHECK(7)=6=state(s), this transition also succeeds. The state transition diagram indicates that a transition occurs from state 6 to state 7 as indicated by the transition label C. The processing is completed for all the characters of the input text, and the finally obtained state 7 is the terminal in the state transition diagram. As a result, the text ABC is accepted.

Non-Patent Document 1: Author: Junichi AOE, Title: An Efficient Implementation of Finite State Machines Using Double-Array Structures, Reference: Journal of the Institute of Electronics, Information and Communication Engineers D, Vol. J70-D No4. pp. 653-662, April, 1987

### DISCLOSURE OF THE INVENTION

### Problems to be Solved by the Invention

The following analysis is given by the present invention.

All the disclosed contents of non-Patent Document 1 given above are hereby incorporated by reference into this specification.

The conventional double-array method cannot efficiently reduce the information amount of the state transition table because of the following reason when the state transition table is not sparse. That is, the double-array method reduces the information amount using the property that the state transition table contains many elements for which a transition destination is not defined. In other words, if the state transition table is not sufficiently sparse, the information amount cannot be reduced much. An example of an application, in which the state transition table does not become sparse easily, is a text search that searches a pattern containing a regular expression. In such a text search, all alphabetic characters (A-Z) and all numeric characters (0-9) are sometimes processed together. In this case, the state transition table does not become sufficiently sparse. FIGS. 12(a) and 12(b) show examples that obviously show this condition.

FIG. 12(a) shows a state transition diagram and a state transition table used to check for a match in the pattern “A[A-Za-z0-9] [A-F0-9]” that includes a regular expression. [A-Za-z0-9] and [A-F0-9] are one type of regular expression called the character class. [A-Za-z0-9] means one character of uppercase/lowercase alphabetic characters and numeric characters, and [A-F0-9] means one digit of hexadecimal numbers. This means that the state transition table shown in FIG. 12(b) accepts texts such as AzC, A90, etc. However, because transition destinations are defined for multiple inputs in the current states S1 and S2, the state transition table is not obviously sparse. This means that the double-array method, if applied to the state transition table, does not greatly reduce the information amount.

In view of the problems described above, it is an object of the present invention to provide redundancy elimination means that reduces the information amount of the state transition table and state transition means that performs a state transition using the information from which redundancy is eliminated, even if transition destinations are defined for almost or all elements of the state transition table in a finite state machine.

### Means to Solve the Problems

To achieve the above object, there is provided an information storing/retrieving method for a state transition table in a first aspect of the present invention, comprising the steps of (a) in a state transition table in which a plurality of transition destinations are made to correspond to a plurality of states and a plurality of inputs, collecting inputs, which have the same transition destination and whose values are contiguous, into one set to configure the plurality of inputs as a plurality of sets; (b) sorting the plurality of sets so that sets, which share the same transition destination, become adjacent; (c) storing input lower-limit values or upper-limit values and non-duplicate transition destination(s), included in the sorted sets, into a memory in the sorted order to reduce information amount of the state transition table; (d) when one state and one input of the plurality of states and the plurality of inputs are given, referencing the memory to retrieve a transition destination and lower-limit value or upper-limit value of one or more sets corresponding to the state and comparing the retrieved lower-limit value or upper-limit value with the input value to identify a set, to which the given input belongs, based on the comparison result; and (e) retrieving a transition destination from the identified set for determining the transition destination as a next state. There is also provided a program causing a computer to perform the method.

There is provided a state transition table information storing/retrieving device in a second aspect of the present invention, comprising configuration means that, in a state transition table in which a plurality of transition destinations are made to correspond to a plurality of states and a plurality of inputs, collects inputs, which have the same transition destination and whose values are contiguous, into one set to configure the plurality of inputs as a plurality of sets; sort means that sorts the plurality of sets so that sets, which share the same transition destination, become adjacent; storing means that stores input lower-limit values or upper-limit values and non-duplicate transition destination(s), included in the sorted sets, into a memory in the sorted order to reduce an information amount of the state transition table; identification means that, when one state and one input of the plurality of states and the plurality of inputs are given, references the memory to retrieve a transition destination and lower-limit value or upper-limit value of one or more sets corresponding to the state and compares the retrieved lower-limit value or upper-limit value with the input value to identify a set, to which the given input belongs, based on the comparison result; and transition destination determination means that determines a transition destination from the identified set as a next state.

### MERITORIOUS EFFECTS OF THE INVENTION

According to the present invention, one or more sets of inputs, which have the same transition destination for an input and whose values are contiguous, are configured for each of the states in a state transition table, and the input minimum values or maximum values included in the sets are recorded in the memory as information indicating the positions of the sets. So, the information amount of the state transition table is reduced even if the state transition table is not sparse, and the amount of memory for storing the state transition table is reduced.

In addition, according to the present invention, one or more sets of inputs, which have the same transition destination for an input and whose values are contiguous, are configured for each of the states in a state transition table, and the non-duplicate transition destinations are recorded in the memory by sorting those sets with the transition destinations of the sets, which share the same transition destination, as the key so that the sets sharing the same transition destination become adjacent. Thus, when the state transition table contains elements that correspond to different inputs but have the same transition destination, the information amount of the state transition table is reduced and the amount of memory for storing the state transition table is reduced.

### BRIEF DESCRIPTION OF THE DRAWINGS

FIG. 1 is a diagram showing a generalized finite state machine.

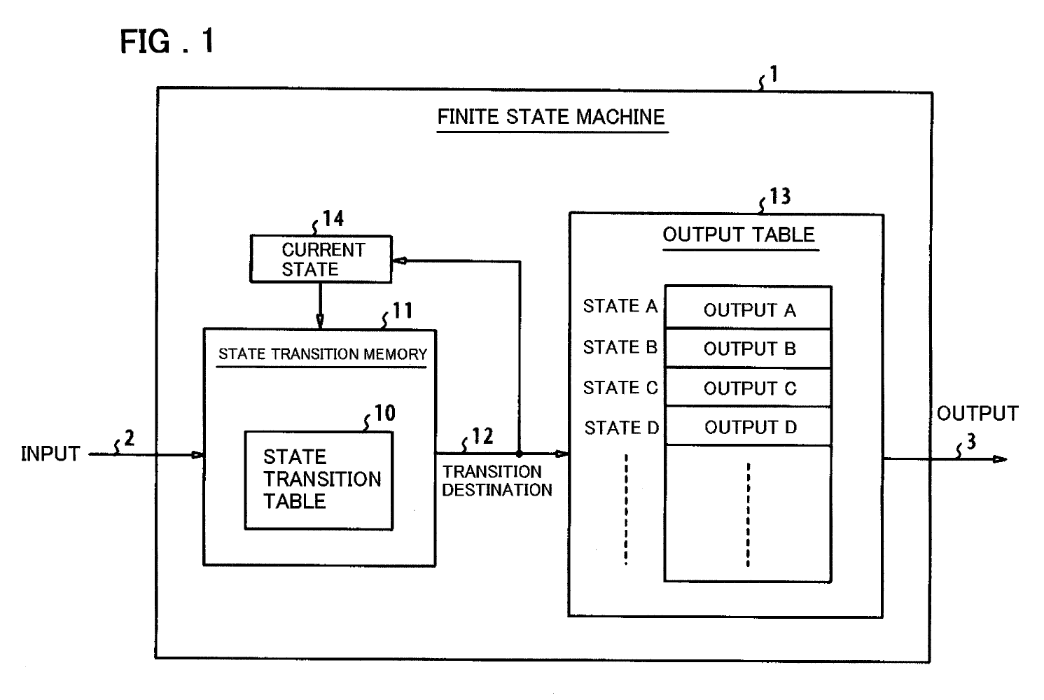

FIG. 2 is a diagram showing a state transition table represented most simply.

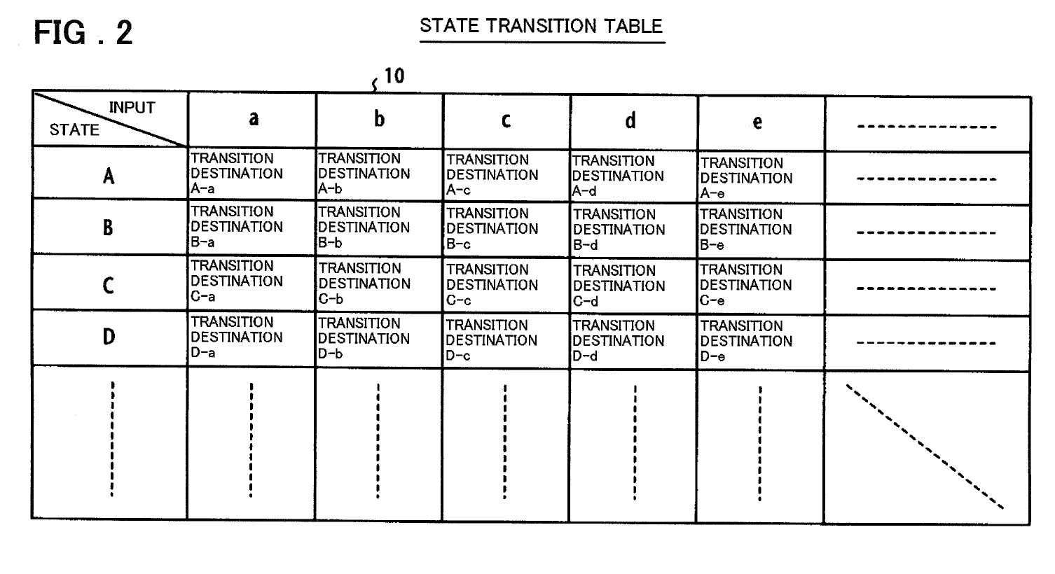

FIG. 3 is a flowchart showing a procedure for reducing the information amount of an input-transition destination table.

FIG. 4 is a diagram showing an algorithm of the flowchart in FIG. 3 coded as a program.

FIG. 5 (FIGS. 5A, 5B) is a diagram showing an input-transition destination table in which the relation between inputs and transition destinations for one state in a state transition table is recorded.

FIG. 6 (FIGS. 6A, 6B) is a diagram showing a section-transition destination table indicating the correspondence between one or more sections, which are included in the input-transition destination table, and the transition destinations of those sections.

FIG. 7 (FIGS. 7A-7F) is a diagram showing a sorted section-transition destination table, non-duplicate transition destination cells, and separator flag cells.

FIG. 8 is a diagram showing how a number-of-sections cell, sorted section lower-limit value cells, separator flag cells, and non-duplicate transition destination cells are stored in a state transition memory.

FIG. 9 (FIGS. 9A, 9B) is a flowchart showing the procedure for determining the transition destination corresponding to an input using information stored in the state transition memory.

FIG. 10 is a diagram showing the algorithm of the flowchart in FIG. 9 coded as a program.

FIG. 11 (FIGS. 11A-11C) is a diagram showing the double-array method in the conventional technology.

FIG. 12 (FIGS. 12A, 12B) is a diagram obviously showing the problem with the double-array method in the conventional technology.

### EXPLANATIONS OF SYMBOLS

1 Finite state machine
2 Input
3 Output
10 State transition table
11 State transition memory
12 Transition destination
13 Output table
14 State
100 Input-transition destination table
101 Section-transition destination table
102 Sorted section-transition destination table
105 Number-of-sections cell
110 Section lower-limit value cell
111 Section upper-limit value cell
112 Section transition destination cell
120 Sorted section lower-limit value cell
121 Sorted section upper-limit value cell
122 Sorted section transition destination cell
130 Separator flag cell
131 Non-duplicate transition destination cell

### PREFERRED MODES FOR CARRYING OUT THE INVENTION

The following describes various application modes of the present invention.

### (Mode 1)

According to a first aspect of the present invention, an information storing/retrieving method for a state transition table can be performed, comprising the steps of:

(a) in a state transition table in which a plurality of transition destinations are made to correspond to a plurality of states and a plurality of inputs, collecting inputs, which have the same transition destination and whose values are contiguous (or continuous), into one set to configure the plurality of inputs as a plurality of sets;

(b) sorting the plurality of sets so that sets, which share the same transition destination, become adjacent;

(c) storing input lower-limit values or upper-limit values and non-duplicate transition destinations, included in the sorted sets, into a memory in the sorted order to reduce information amount of the state transition table;

(d) when one state and one input of the plurality of states and the plurality of inputs are given, referencing the memory to retrieve a transition destination and lower-limit value or upper-limit value of one or more sets corresponding to the state and comparing the retrieved lower-limit value or upper-limit value with the input value to identify a set, to which the given input belongs, based on the comparison result; and

(e) retrieving a transition destination from the identified set for determining the transition destination as a next state.

### (Mode 2)

In the step of (a), an input-transition table is generated for the inputs of the state transition destination table, the input-transition table comprising a plurality of cells, in which a plurality of input values having the same transition destination and having contiguous values are stored, and a plurality of cells in which transition destinations corresponding to the plurality of input values are stored;

in the step of (b), all cells are extracted from the input-transition table and the cells are arranged by lower-limit value or upper-limit value of the inputs and by transition destination to generate a set-transition destination table and, in addition, the set-transition destination table is sorted so that a plurality of rows sharing the same transition destination become adjacent in the set-transition destination table to generate a sorted set-transition destination table; and

in the step of (c), the non-duplicate transition destinations are determined from the sorted set-transition destination table.

### (Mode 3)

If the input lower-limit values are stored in the memory in the step of (c), the step of (d) comprises the steps of:

if the input value is equal to or larger than a minimum value of the one or more retrieved lower-limit values, selecting one or more lower-limit values equal to or smaller than the input value and identifying a set, which has a maximum value of the selected lower-limit values, as a set to which the input belongs; or

if the input value is smaller than a minimum of the one or more retrieved lower-limit values, identifying a set, whose lower-limit value is lowest in the sorted set-transition destination table, as a set to which the input belongs.

### (Mode 4)

In addition, if the input upper-limit values are stored in the memory in the (c), the (d) comprises:

if the input value is equal to or smaller than a maximum value of the one or more retrieved upper-limit values, selecting one or more upper-limit values equal to or smaller than the input value and identifying a set, which has a minimum value of the selected upper-limit values, as a set to which the input belongs; or

if the input value is larger than a maximum value of the one or more retrieved upper-limit values, identifying a set, whose upper-limit value is highest in the sorted set-transition destination table, as a set to which the input belongs.

### (Other Modes)

The modes of the information storing/retrieving method for a state transition table described above can be applied also to a state transition table information storing/retrieving device and program of the present invention.

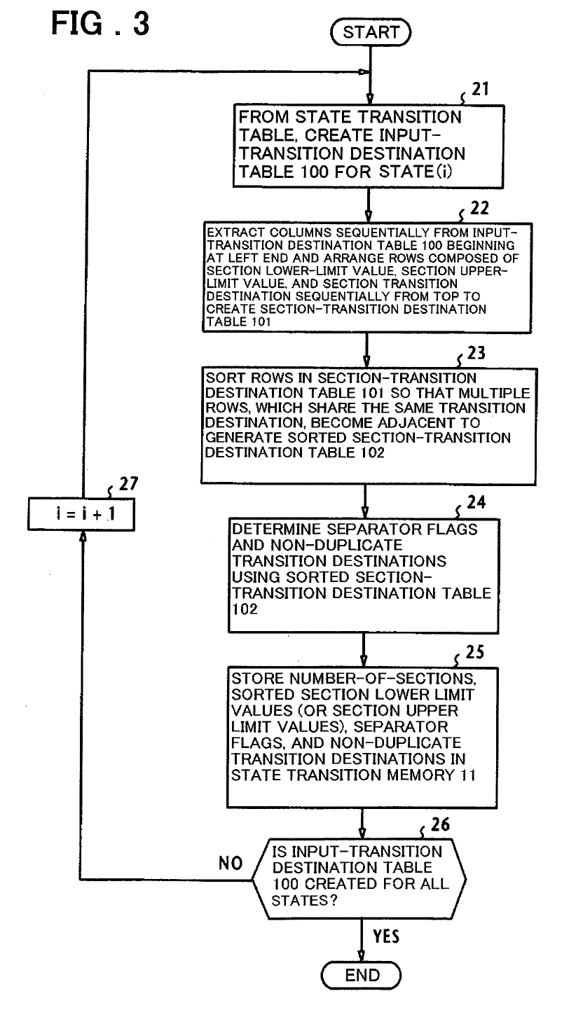

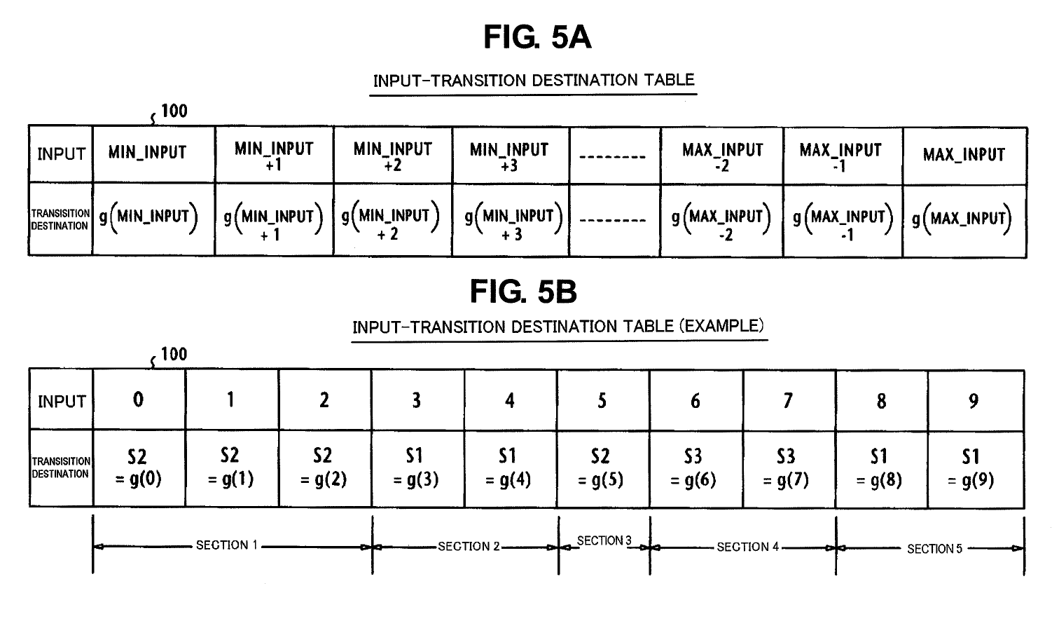

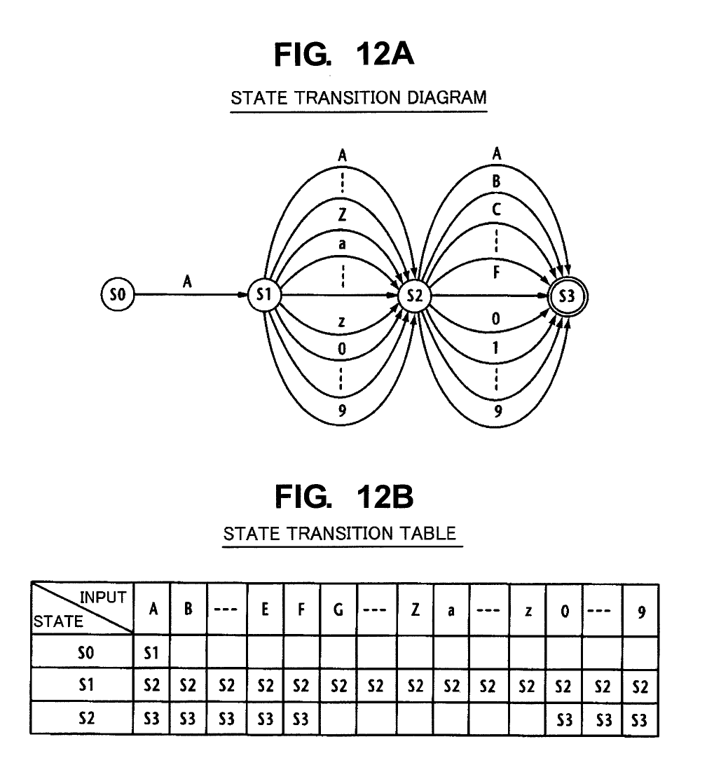

Exemplary embodiments of the present invention will be described in detail below with reference to the drawings. With reference to the flowchart in FIG. 3, the following describes a method for reducing the information amount of a state transition table and a method for performing a state transition using the reduced information. First, in step 21, an input-transition table 100 for the input [sic. state] (i) is created from the state transition table as shown in FIG. 5. FIG. 5(a) shows a general method, and FIG. 5(b) shows a concrete example. Referring to FIG. 5, the input-transition destination table 100 is a table showing the relation between the input(i) [sic.] and the transition destination for one state [(i)] indicated by the state transition table in FIG. 12, and is a part of the state transition table (FIG. 12). The symbol MIN_INPUT is the minimum value that the input can assume, and MAX_INPUT is the maximum value. The symbol g(X) indicates the transition destination corresponding to the input X.

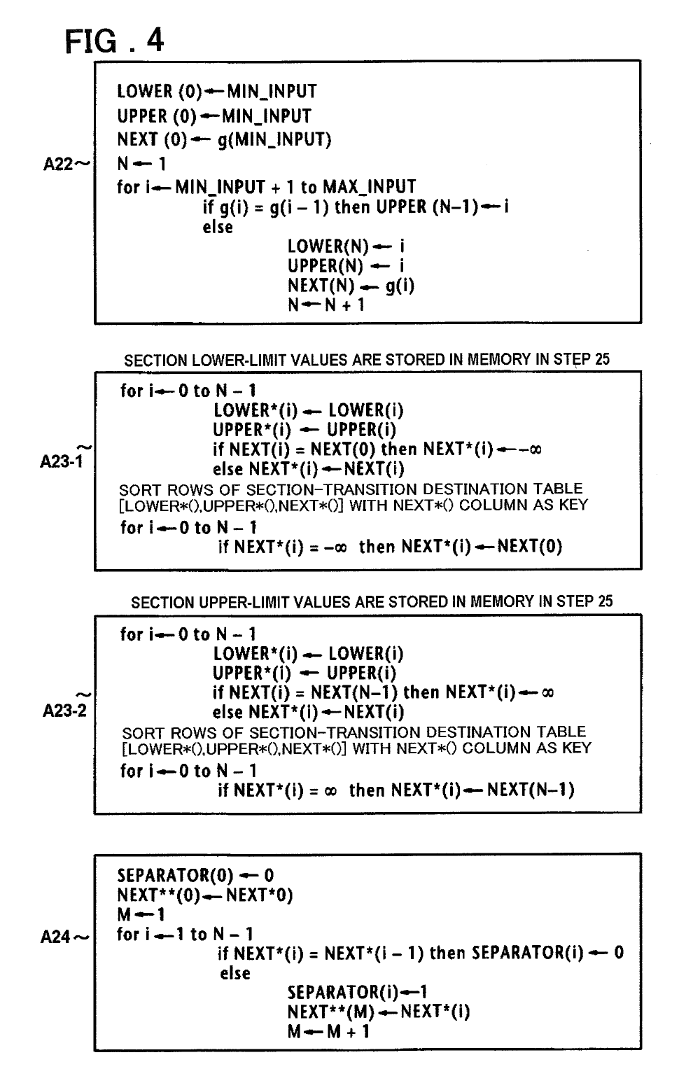

FIG. 4 shows algorithms corresponding to the major steps in FIG. 3 and coded as programs. The procedure for reducing the information amount of the input-transition destination table 100 includes steps A22-A24 in FIG. 4.

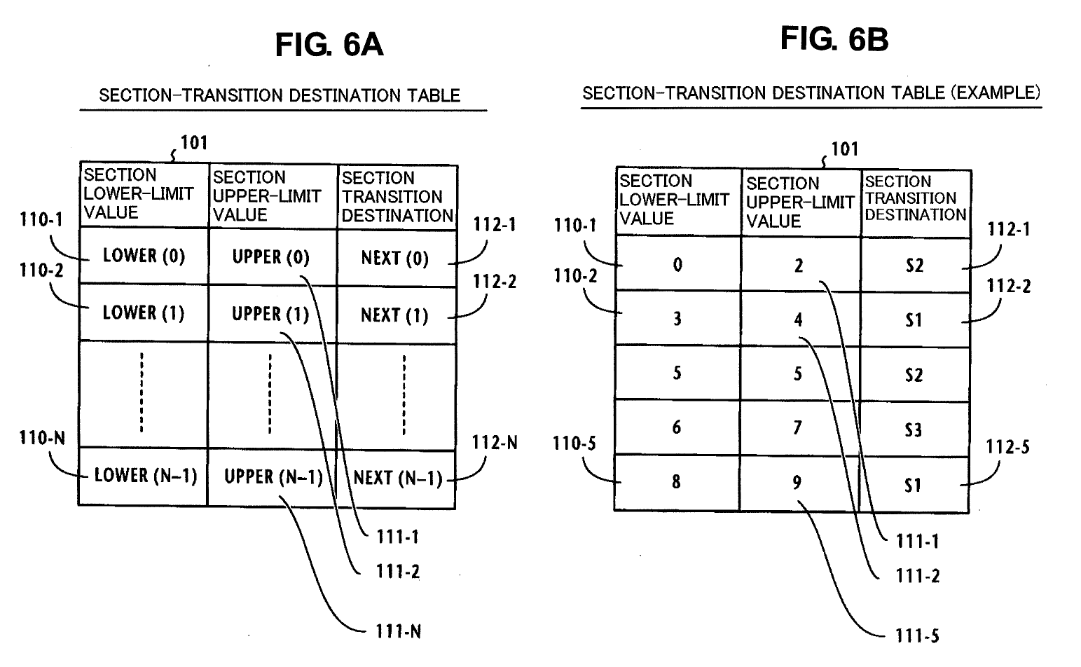

Next, in step 22 in FIG. 3, the columns are extracted sequentially from the input-transition destination table 100 beginning at the left end, and the rows each composed of the section lower-limit value, the section upper-limit value, and the section transition destination are arranged sequentially beginning at the top to generate a section-transition destination table 101 shown in FIG. 6. A section refers to a set of inputs that have the same transition destination in the input-transition destination table 100 and have serial numbers.

The following describes the definition of the section.

(1) A section is a set of at least one input in the input-transition destination table 100.
(2) All inputs belonging to one section share the same transition destination.
(3) All inputs belonging to one section have serial numbers.
(4) A set of inputs which satisfies the above conditions and has the largest size is a section.
Because of its property, each section is uniquely identified by the lower-limit value and the upper-limit value of the inputs belonging to the section. The section-transition destination table 101 indicates the correspondence between one or more sections, included in the input-transition destination table 100, and the transition destinations of those sections. In this section-transition destination table 101, the minimum value of the inputs belonging to a section is represented as the lower-limit value LOWER(0)-LOWER(N−1), the maximum value of the inputs belonging to a section is represented as the upper-limit value UPPER(0)-UPPER(N−1) of the section. In addition, the transition destination of a section is represented as the section transition destination NEXT(0)-NEXT(N−1). N is the number of sections included in the input-transition destination table 100 shown in FIG. 5. The lower-limit value LOWER(0) of the first section is equal to MIN_INPUT, and the upper-limit value UPPER(N−1) of the Nth section is equal to MAX_INPUT.

The variables used in the algorithm A22 in FIG. 4, corresponding to step 22, are defined as follows.

(A) LOWER(X)=Section lower-limit value cell 110-(X+1) of table 101
(B) UPPER(X)=Section upper-limit value cell 111-(X+1) of table 101
NEXT(X)=Section transition destination cell 112-(X+1) of table 101

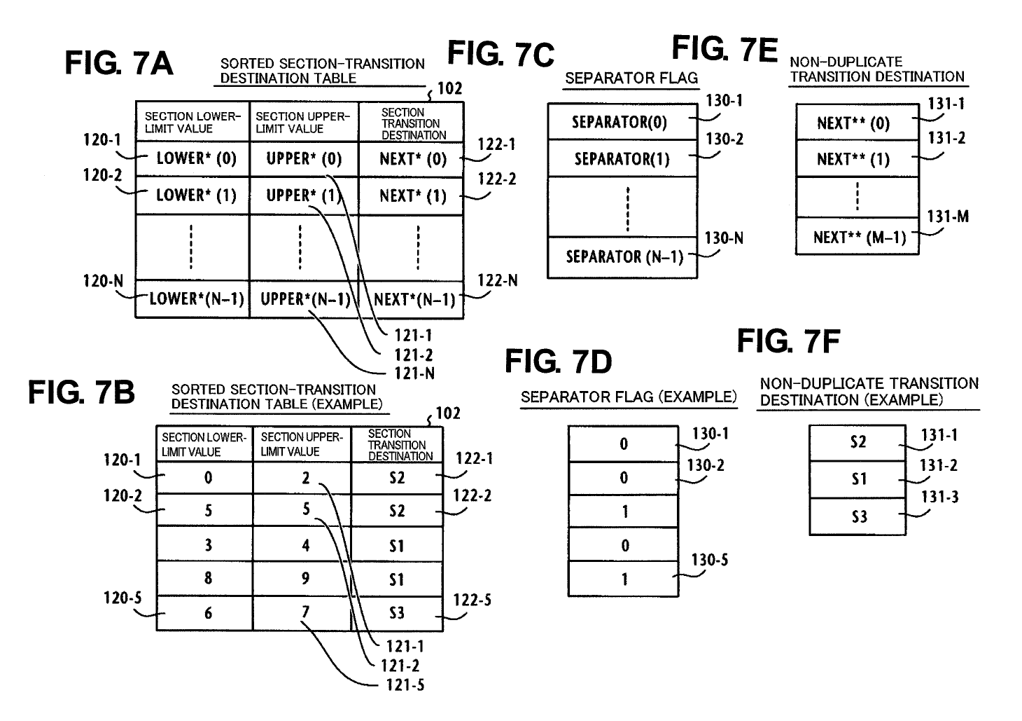

Next, in step 23, the rows in the section-transition destination table 101 are sorted with the content of the section transition destination cell as the key so that multiple rows, which share the same transition destination, become adjacent. FIG. 7 (FIGS. 7A-7F) is a diagram showing a sorted section-transition destination table 102 that has been sorted.

When the section lower-limit values are stored in the state transition memory 11 in step 25 that will be described later, the rows are sorted in step 23 so that sort conditions 1 and 2 are satisfied based on the following definition of the variables.

### (Definition of Variables)

(1) LOWER*(X)=Section lower-limit value cell 120-(X+1),
(2) UPPER*(X)=Section upper-limit value cell 121-(X+1),
(3) NEXT*(X)=Section transition destination cell 122-(X+1).
(Sort condition 1)

### LOWER*(0)=LOWER(0),

### UPPER*(0)=UPPER(0),

### NEXT*(0)=NEXT(0).

### (Sort Condition 2)

For all combinations of X and Y (0≦X<Y<N) that satisfy NEXT*(X)=NEXT*(Y), NEXT*(Z)=NEXT*(X), X<∀Z<Y.

In other words, the sort condition 1 states that “Before and after the sorting, the content of the first row of the section-transition destination table 101 must remain unchanged”, and the sort condition 2 states that “In the section transition destination cells 122-1-122-N of the sorted table 102, the rows having the same value must be adjacent”.

If the known sort algorithm (bubble sort, heap sort, quick sort, merge sort, etc.) would be directly applied, the sort condition 2 given above is satisfied but the sort condition 1 is not. To make the known sort algorithm applicable, the following change is added to the section transition destination cells 112-1-112-N before the sorting so that the sort condition 1 is satisfied. “For 0≦X≦N, NEXT(X)←minus ∞ if NEXT(X) is equal to NEXT(0)”. After this change is entered, the known sort algorithm is used to sort the rows with the transition destination of the section transition destination cells 112-1-112-N as a key so that multiple rows sharing the same transition destination become adjacent. The change described above prevents a row, to which the section transition destination cell 112-1 whose transition destination is rewritten to minus ∞ belongs, from being moved to another row. Thus, the sort condition 1 is satisfied.

On the other hand, when the section upper-limit values are stored in the state transition memory 11 in step 25 that will be described later, the variables in step 23 are defined so that the sort conditions 1 and 2 given below are satisfied.

### (Sort Condition 1)

### LOWER*(N−1)=LOWER(N−1),

### UPPER*(N−1)=UPPER(N−1),

### NEXT*(N−1)=NEXT(N−1)

### (Sort Condition 2)

For all combinations of X and Y (0≦X<Y<N) that satisfy NEXT*(X)=NEXT*(Y), NEXT*(Z)=NEXT*(X), X<∀Z<Y.

In other words, the sort condition 1 states that “Before and after the sorting, the content of the last row of the section-transition destination table 101 must remain unchanged”, and the sort condition 2 states that “In the section transition destination cells 122-1-122-N of the sorted table 102, the rows having the same value must be adjacent”.

If the known sort algorithm (bubble sort, heap sort, quick sort, merge sort, etc.) would be directly applied, the sort condition 2 given above is satisfied but the sort condition 1 is not. To make the known sort algorithm applicable, the following change is entered to the section transition destination cells 112-1-112-N before the sorting so that the sort condition 1 is satisfied. “For 0≦X<N, NEXT(X)←plus ∞ if NEXT(X) is equal to NEXT(N−1)”. After this change is entered, the known algorithm is used to sort the rows so that the rows sharing the same transition destination become adjacent. The change described above prevents a row, to which the section transition destination cell 112-N whose transition destination is rewritten to plus ∞ belongs, from being moved to another row. Thus, the sort condition 1 is satisfied.

Next, in step 24, non-duplicate transition destination cells 131-1-131-M and separator flag cells 130-1-130-N are obtained from the sorted section-transition destination table 102, where M is the number of unique values included in the sorted section transition destination cells 122-1-122-N. For example, the sorted section transition destination cells 122-1-122-5 of the sorted section-transition destination table 102 in FIG. 7B contain S2, S2, S1, S1, and S3, respectively. Out of those destinations, because S1 and S2 occur multiple times, the number of unique values are three, S2, S1, and S3, and therefore M=3. The non-duplicate transition destination cells 131-1-131-M build an array created by removing duplicate values from the sorted section transition destination cells 122-1-122-N and by eliminating vacant elements and shifting the elements upward. The separator flag cells 130-1-130-N take a value of 0 or 1 to indicate a change point in the values of the sorted section transition destination cells 122-1-122-N. More specifically, if the sorted section transition destination cell 122-X and the sorted section transition destination cell 122-(X−1) have different values, the value of the separator flag cell 130-X(2≦X<N) is 1; if they are equal, the value is 0. The value of the separator flag cell 130-1 is always 0.

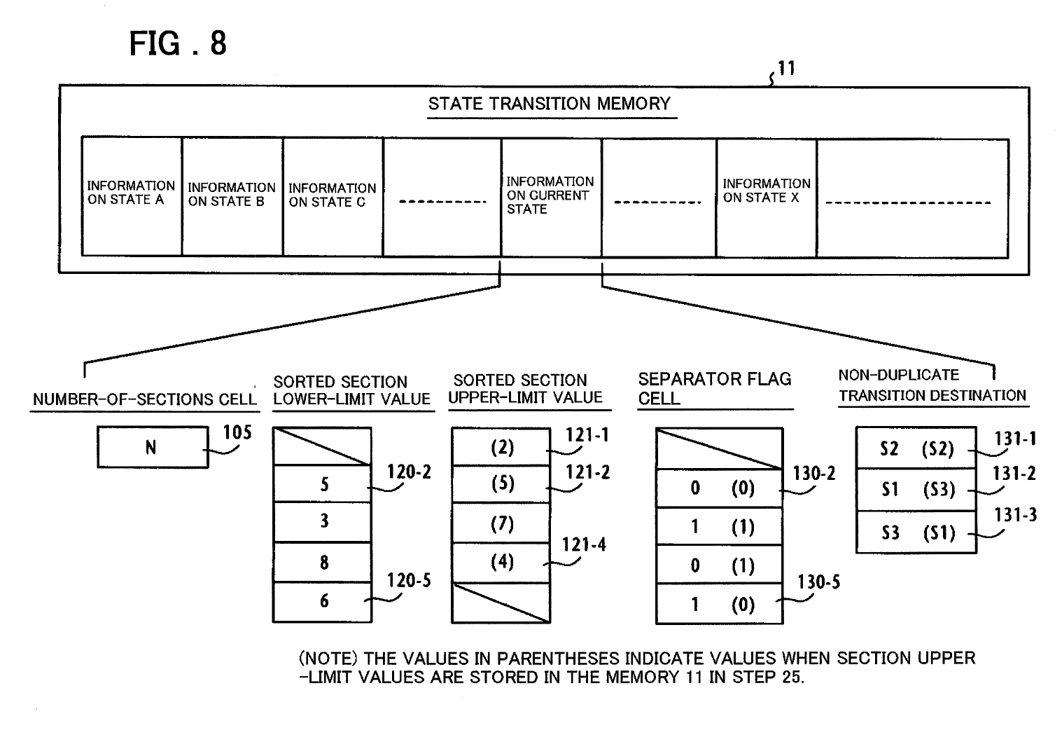

Next, in step 25, a number-of-sections cell 105 (value=N), sorted section lower-limit value cells 120-2-120-N (or section upper-limit value cells 121-1-121-(N−1)), separator flag cells 130-2-130-N, and non-duplicate transition destination cells 131-1-131-M are stored in the state transition memory 11 as shown in FIG. 8. However, if the section lower-limit values are stored, the sorted section upper-limit value cells 121-1-121-N, which are equal to the values generated by subtracting 1 from the sorted section lower-limit value cells 120-1-120-N or to MAX_INPUT, are not stored in the state transition memory 11 because they are redundant information. Similarly, if the section upper limit values are stored, the sorted section lower-limit value cells 120-1-120-N, which are equal to the values generated by adding 1 to the sorted section upper-limit value cells 121-1-121-N or to MIN_INPUT, are not stored in the state transition memory 11 because they are redundant information.

When the section lower-limit values are stored in the memory 11 in step 25, the sorted section lower-limit value cell 120-1 is always equal to MIN_INPUT and the separator flag cell 130-1 is always 0 as shown in FIG. 8 and, so, this information need not be stored in the state transition memory 11.

Similarly, when the section upper-limit values are stored in the memory 11, the sorted section upper-limit value cell 121-N is always equal to MAX_INPUT and the separator flag cell 130-1 is always 0 as indicated by the values in parentheses and, so, this information need not be stored in the state transition memory 11.

The method has been described for reducing the information amount of the input-transition destination table 100 in FIG. 5 for one input [sic. state]. Because this input-transition destination table 100 describes the relation between the input and the transition destination for one state included in the state transition table, a check is made in step 26 if the input-transition destination table 100 is created for all inputs [sic. states]. If the table is created for all inputs, the processing is terminated; if not, the input [sic. state] pointer (i) is incremented by one in step 27 and control is passed back to step 21 to repeat the processing described above. This repeated processing can reduce the information amount of the whole state transition table.

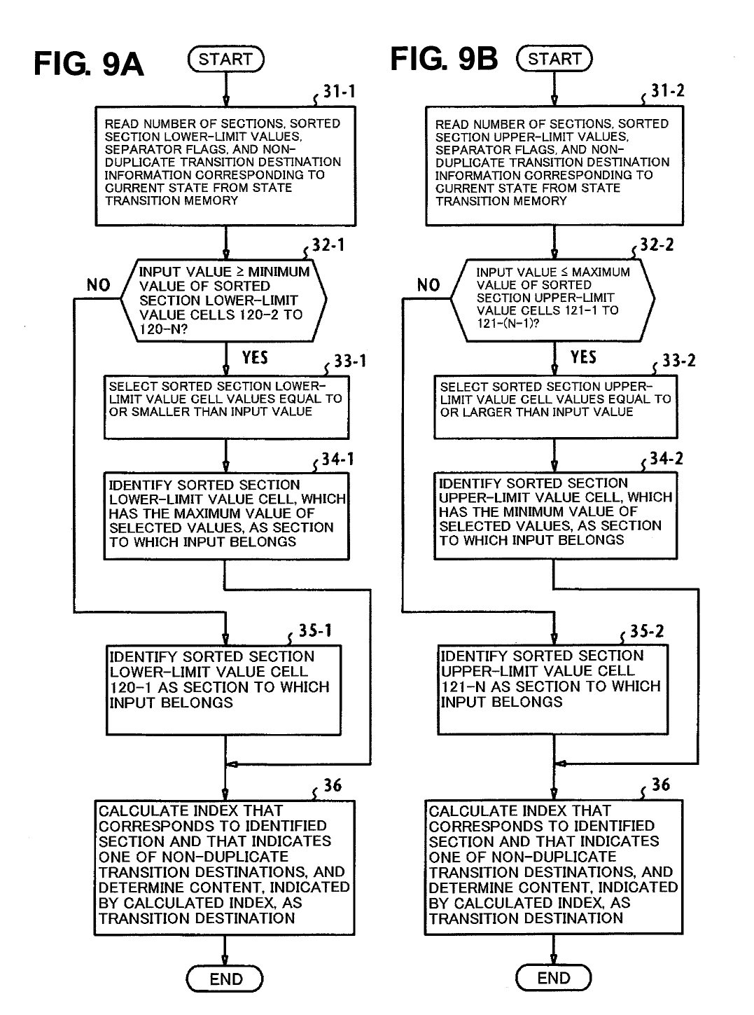

Next, FIG. 9A and FIG. 9B show the method that is used for finding the transition destination corresponding to an input, which is given to the state transition table, using the state transition memory 11 in FIG. 8. FIG. 9A shows the case in which section lower-limit values are stored in the memory 11 in step 25 in FIG. 3, and FIG. 9B shows the case in which section upper-limit values are stored.

First, in step 31-1 in FIG. 9A, the value N of the number-of-sections cell 105, sorted section lower-limit value cells 120-2-120-N, separator flag cells 130-2-130-N, and non-duplicate transition destination cells 131-1-131-M corresponding to the current state are read from the state transition memory 11 shown in FIG. 8.

Next, in step 32-1, the section (set) to which the input belongs is identified. For all Xs(2≦∀X≦N) that satisfy “input value≧section lower-limit value of sorted cell 120-X”, the maximum value of the section lower-limit values is determined from the sorted cells 120-X. If the section lower-limit value of the sorted cell 120-Y(2≦∃Y≦N) is equal to the maximum value, the input belongs to the section including the sorted section lower-limit value cell 120-Y. If there is no X(2≦X≦N) that satisfies “input value≧section lower-limit value of sorted cell 120-X”, the input belongs to a section including the sorted section lower-limit value cell 120-1.

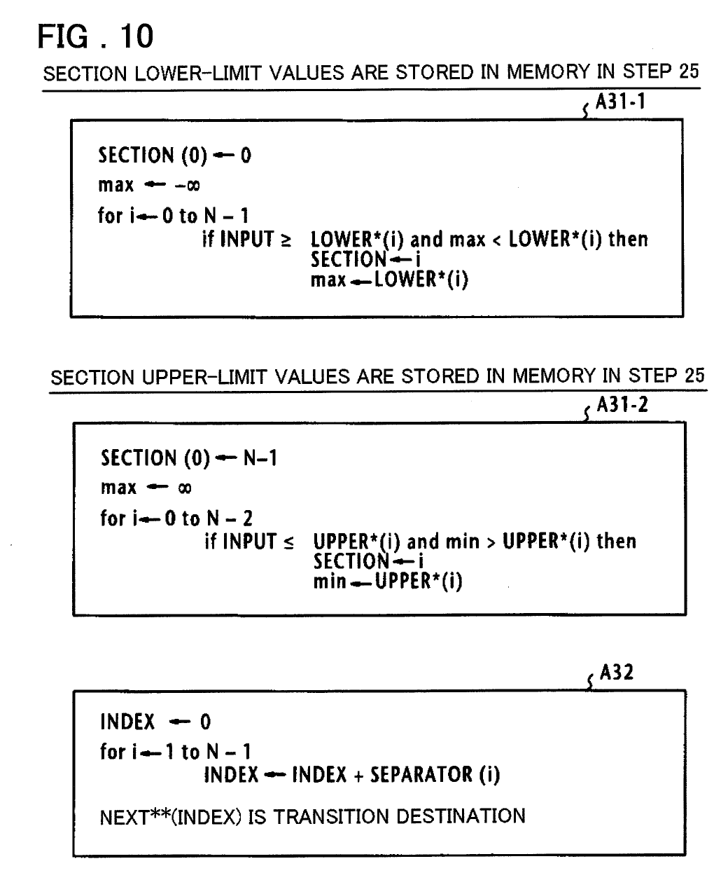

For example, the values of the section lower-limit value cells 120-X(2≦X≦5) correspond to the value of X and are arranged in the order of 5, 3, 8, and 6, in which if the input value is 7, the three values 5, 3, and 6 are values equal to or smaller than 7. The maximum value of 5, 3, and 6 is 6. So, the section including the sorted section lower-limit value cell 120-5 is now identified for the input value 7. The input-transition destination table 100 in FIG. 5 indicates that the input value 7 belongs to the section equal to or larger than 6 and equal to or smaller than 7. FIG. 10 shows the algorithm A31-1 corresponding to steps 32-1 to 35-1. Note that the variable SECTION used in this algorithm means that the input belongs to the section including the sorted section lower-limit value cell 120-(SECTION+1).

That is, in step 32-1, if the input value is judged to be equal to or larger than the minimum value of the sorted section lower-limit value cells 120-2 to 120-N, control is passed to step 33-1, the values of the sorted section lower-limit value cells 120 equal to or smaller than the input value are selected and, in step 34-1, the sorted section lower-limit value cell 120 having the maximum value of the selected lower-limit values is identified as the section to which the input belongs.

If it is judged in step 32-1 that the input value is smaller than the minimum value of the lower-limit values in the sorted section lower-limit value cells 120-2 to 120-N, control is passed to step 35-1 and the sorted section lower-limit value cell 120-1 is identified as a section to which the input belongs.

Next, control is passed to step 36. In this step, the index(=sum of corresponding separator flags) that corresponds to the section including the section lower-limit value cell identified in step 34-1 or 35-1 and that indicates one of the non-duplicate transition destination cells 131-1-131-M is calculated, and the content indicated by the calculated index is determined as a transition destination. That is, the sum of the separator flag cells 130-2-130-(SECTION+1) is calculated and the calculated sum is indicated as INDEX. In this case, the transition destination of the section, to which the input belongs, is the non-duplicate transition destination cell 131-(INDEX+1). That is, when the input value is 7, SECTION=(section number)=4 because the identified section is the section lower-limit value cell 120-5. The sum of the separator flag cells 130-2-130-(4+1) is calculated as 0+1+0+1=2=INDEX. Therefore, the transition destination of the section, to which the input belongs, is indicated by the non-duplicate transition destination cell 131-(2+1), that is, S3. The input-state table [sic. input-transition destination table] 100 in FIG. 5 shows that the transition destination corresponding to the input value 7 is S3. FIG. 10 shows the algorithm A32 corresponding to step 36.

Next, in step 31-2 in FIG. 9B, the value N of the number-of-sections cell 105, sorted section upper-limit value cells 121-1-121-(N−1), separator flag cells 130-2-130-N, and non-duplicate transition destination cells 131-1-131-M corresponding to the current state are read from the state transition memory 11 shown in FIG. 8.

Next, in step 32-2, the section (set) to which the input belongs is identified. For all Xs(1≦∀X≦N) that satisfy “input value≦section upper-limit value of sorted cell 121-X”, the minimum value of the section upper-limit values is determined from the sorted cells 121-X. If the section upper-limit value of the sorted cell 121-Y(1≦∃Y<N) is equal to the minimum value, the input belongs to the section including the sorted section upper-limit value cell 121-Y. If there is no X(1≦X<N) that satisfies “input value≦section upper-limit value of sorted cell 121-X”, the input belongs to a section including the sorted section upper-limit value cell 121-N.

For example, the values of the section upper-limit value cells 121-X(1≦X<5) correspond to the value of X and are arranged in the order of 2, 5, 7, and 4. If the input value is 3, the three values 5, 7, and 4 are values equal to or larger than 3. The minimum value of 5, 7, and 4 is 4. So, the section including the sorted section upper-limit value cell 121-4 is identified for the input value 3. The input-transition destination table 100 in FIG. 5 indicates that the input value 3 belongs to the section equal to or larger than 3 and equal to or smaller than 4. FIG. 10 shows the algorithm A31-2 corresponding to steps 32-2 to 35-2. Note that the variable SECTION used in this algorithm means that the input belongs to the section including the sorted section upper-limit value cell 121-(SECTION+1).

That is, in step 32-2, if the input value is judged to be equal to or smaller than the maximum value of the sorted section upper-limit value cells 121-1 to 121-(N−1), control is passed to step 33-2, the values of the sorted section upper-limit value cells 121 equal to or larger than the input value are selected and, in step 34-2, the sorted section upper-limit value cell 121 having the minimum value of the selected upper-limit values is identified as a section to which the input belongs.

If it is judged in step 32-2 that the input value is larger than the maximum value of the sorted section upper-limit value cells 121-1 to 121-(N−1), control is passed to step 35-2 and the sorted section upper-limit value cell 121-N is identified as a section to which the input belongs.

Next, control is passed to step 36. In this step, the index(=sum of corresponding separator flags) that corresponds to the section including the section upper-limit value cell identified in step 34-2 or 35-2 and that indicates one of the non-duplicate transition destination cells 131-1-131-M is calculated, and the content indicated by the calculated index is determined as a transition destination. That is, the sum of the separator flag cells 130-2-130-(SECTION+1) is calculated and the calculated sum is indicated as INDEX. In this case, the transition destination of the section, to which the input belongs, is the non-duplicate transition destination cell 131-(INDEX+1). That is, when the input value is 3, SECTION=(section number)=3 because the identified section is the section upper-limit value cell 121-4. The sum of the separator flag cells 130-2-130-(3+1) is calculated as 0+1+1=2=INDEX. So, the transition destination of the section, to which the input belongs, is indicated by the non-duplicate transition destination cell 131-(2+1), that is, S1. The input-transition destination table 100 in FIG. 5 shows that the transition destination corresponding to the input value 3 is S1. FIG. 10 shows the algorithm A32 corresponding to step 36.

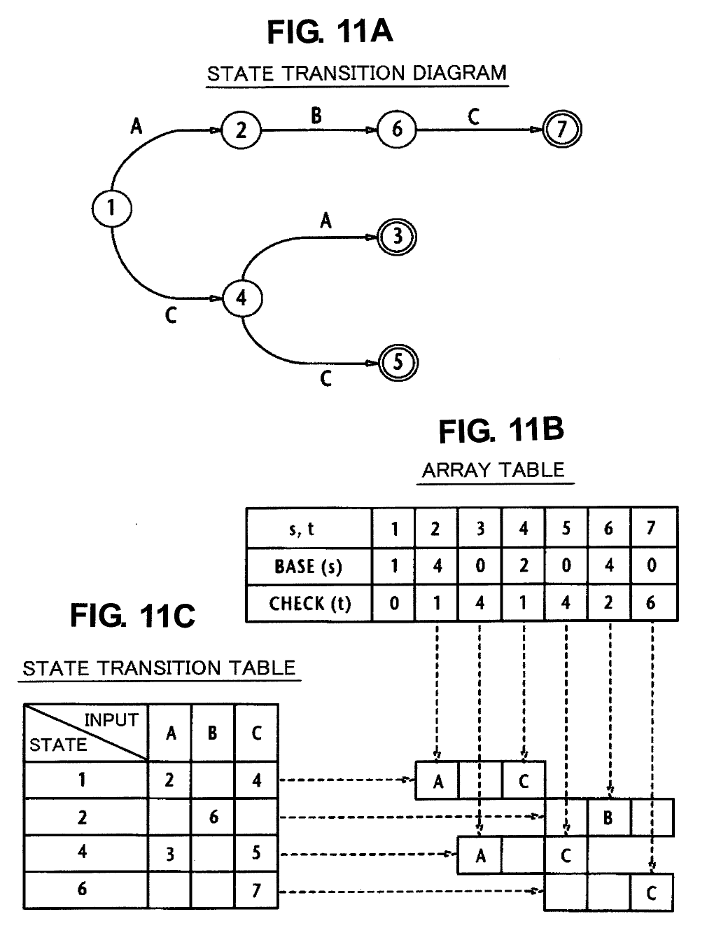

Next, the following quantitatively shows a reduction in the information amount of the state transition table (see FIG. 11C) by means of the method described in this exemplary embodiment.

More specifically, the information amount of the state transition table is compared with the information amount after the reduction. The following focuses on a reduction in one state in the state transition table for easy comparison.

First, the information amount is formulated as follows.

### (Information Amount Before Reduction)

Information amount of one state in state transition table=Information amount of input-transition destination table 100=Number of input types×log 2(total number of states) bits where the number of input types=MAX_INPUT−MIN_INPUT+1

(Information Amount after Reduction)

Information amount of value N of number-of-sections cell 105=log 2(N) bits

Information amount of sorted section lower-limit value cells 120-2-120-N=N×log 2 (number of input types) bits

Information amount of separator flag cells 130-2-130-N=N−1 bits

Information amount of non-duplicate transition destination cells 131-1-131-M=M×log 2(total number of states) bits

So, the total is log 2(N)+N×log 2(number of input types)+N−1+M×log 2(total number of states).

Because there are many variables, the fixed numbers are used for the total number of states and the number of input types. The following shows the two comparisons when the number of input types is fixed to 256 and when the total number of states is 64 and 65536.

First, let the total number of states=64 and the number of input types=256. Let M=total number of states=64 for easy calculation.

In this case, if the value N of the number-of-sections cell 105 is equal to or smaller than 127, the information amount after the reduction by the method in this exemplary embodiment is smaller than the information amount of the input-transition destination table 100 (Reason: The inequality “1536>log 2(N)+N×9+383” is derived from the above conditions, and the solution for this inequality is N≦127).

Because it is extremely rare in a general state transition table that an average number of transitions from one state exceeds 127, the method in this exemplary embodiment is very effective in reducing the information amount of the state transition table.

Next, let total number of states=65536 and the number of input types=256. Let M be the value N of the number-of-sections cell 105 for easy calculation.

In this case, if the number-of-sections 105(N) is equal to or smaller than 163, the information amount after the reduction by the method in this exemplary embodiment is smaller than the information amount of the input-transition destination table 100 (Reason: The inequality “4096>log 2(N)+N×25−1” is derived from the above conditions, and the solution of this inequality is N≦163).

Because it is extremely rare in a general state transition table that the average number of transitions from one state exceeds 163, the method in this exemplary embodiment is very effective in reducing the information amount of a state transition table.

While the present invention has been described with reference to the exemplary embodiments above, the exemplary embodiments and the examples may be changed and adjusted in the scope of all disclosures (including claims) of the present invention and based on the basic technological concept thereof. In the scope of the claims of the present invention, various disclosed elements may be combined and selected in a variety of ways.

1. An information storing/retrieving method for a state transition table, comprising:
(a) in a state transition table in which a plurality of transition destinations are made to correspond to a plurality of states and a plurality of inputs, collecting inputs, which have the same transition destination and whose values are contiguous, into one set to configure the plurality of inputs as a plurality of sets;
(b) sorting the plurality of sets so that sets, which share the same transition destination, become adjacent;
(c) storing input lower-limit values or upper-limit values and non-duplicate transition destination(s), included in the sorted sets, into a memory in the sorted order to reduce information amount of said state transition table;
(d) when one state and one input of the plurality of states and the plurality of inputs are given, referencing the memory to retrieve a said non-duplicate transition destination(s) and lower-limit value or upper-limit value of one or more sets corresponding to the state and comparing the retrieved lower-limit value or upper-limit value with the input value to identify a set, to which the given input belongs, based on the comparison result; and
(e) retrieving a transition destination corresponding to the identified set from among said non-duplicate transition destinations for determining the transition destination as a next state.

2. The information storing/retrieving method for a state transition table as defined by claim 1, wherein
in said (a), an input-transition table is generated for each state of said state transition table, said input-transition destination table comprising a plurality of cells, in which a plurality of input values having the same transition destination and having contiguous values are stored, and a plurality of cells in which transition destinations corresponding to the plurality of input values are stored,
in said (b), all cells are extracted from said input-transition destination table and the cells are arranged by lower-limit value or upper-limit value of the inputs and by transition destination to generate a set-transition destination table and, in addition, said set-transition destination table is sorted so that a plurality of rows sharing the same transition destination become adjacent in said set-transition destination table to generate a sorted set-transition destination table, and
in said (c), the non-duplicate transition destinations are determined from said sorted set-transition destination table.

3. The information storing/retrieving method for a state transition table as defined by claim 1, wherein
if the input lower-limit values are stored in the memory in said (c), said (d) comprises:
if the input value is equal to or larger than a minimum value of the one or more retrieved lower-limit values, selecting one or more lower-limit values equal to or smaller than the input value and identifying a set, which has a maximum value of the selected lower-limit values, as a set to which the input belongs, or
if the input value is smaller than a minimum of the one or more retrieved lower-limit values, identifying a set, whose lower-limit value is lowest in a sorted set-transition destination table, as a set to which the input belongs.

4. The information storing/retrieving method for a state transition table as defined by claim 1, wherein
if the input upper-limit values are stored in the memory in said (c), said (d) comprises:
if the input value is equal to or smaller than a maximum value of the one or more retrieved upper-limit values, selecting one or more upper-limit values equal to or smaller than the input value and identifying a set, which has a minimum value of the selected upper-limit values, as a set to which the input belongs, or
if the input value is larger than a maximum value of the one or more retrieved upper-limit values, identifying a set, whose upper-limit value is highest in a sorted set-transition destination table, as a set to which the input belongs.

5. A state transition table information storing/retrieving device comprising:
a configuration unit that, in a state transition table in which a plurality of transition destinations are made to correspond to a plurality of states and a plurality of inputs, collects inputs, which have the same transition destination and whose values are contiguous, into one set to configure the plurality of inputs as a plurality of sets;
a sort unit that sorts the plurality of sets so that sets, which share the same transition destination, become adjacent;
a storing unit that stores input lower-limit values or upper-limit values and non-duplicate transition destination(s), included in the sorted sets, into a memory in the sorted order;
an identification unit that, when one state and one input of the plurality of states and the plurality of inputs are given, references the memory to retrieve said non-duplicate transition destination(s) and lower-limit value or upper-limit value of one or more sets corresponding to the state and compares the retrieved lower-limit value or upper-limit value with the input value to identify a set, to which the given input belongs, based on the comparison result; and
a transition destination determination unit that determines a transition destination corresponding to the identified set from among said non-duplicate transition destinations as a next state.

6. The state transition table information storing/retrieving device as defined by claim 5, wherein
said configuration unit generates an input-transition table for each state of said state transition table, said input-transition destination table comprising a plurality of cells, in which a plurality of input values having the same transition destination and having contiguous values are stored, and a plurality of cells in which transition destinations corresponding to the plurality of input values are stored;
said sort unit extracts all cells from said input-transition table and arranges the cells by lower-limit value or upper-limit value of the inputs and by transition destination to generate a set-transition destination table and, in addition, sorts said set-transition destination table so that a plurality of rows sharing the same transition destination become adjacent in said set-transition destination table to generate a sorted set-transition destination table; and
said storing unit determines the non-duplicate transition destinations from said sorted set-transition destination table.

7. The state transition table information storing/retrieving device as defined by claim 5, wherein
if said storing unit stores the input lower-limit values in the memory, said identification unit selects one or more lower-limit values equal to or smaller than the input value if the input value is equal to or larger than a minimum value of the one or more retrieved lower-limit values, and identifies a set, which has a maximum value of the selected lower-limit values, as a set to which the input belongs, or if the input value is smaller than a minimum of the one or more retrieved lower-limit values, identifies a set, whose lower-limit value is lowest in said sorted set-transition destination table, as a set to which the input belongs.

8. The state transition table information storing/retrieving device as defined by claim 6, wherein
if said storing unit stores the input upper-limit values in the memory, said identification unit selects one or more upper-limit values equal to or smaller than the input value if the input value is equal to or smaller than a maximum value of the one or more retrieved upper-limit values, and identifies a set, which has a minimum value of the selected upper-limit values, as a set to which the input belongs, or
if the input value is larger than a maximum value of the one or more retrieved upper-limit values, identifies a set, whose upper-limit value is highest in said sorted set-transition destination table, as a set to which the input belongs.

9. A program that performs the information storing/retrieving method for a state transition table as defined by claim 1.

10. A state-transition-table information storing/retrieving program causing a computer, which processes a state transition table in which a plurality of transition destinations are made to correspond to a plurality of states and a plurality of inputs, to execute:
(a) collecting inputs, which have the same transition destination and whose values are contiguous in the state transition table, into one set to configure the plurality of inputs as a plurality of sets;
(b) sorting the plurality of sets so that sets, which share the same transition destination, become adjacent;
(c) storing input lower-limit values or upper-limit values, included in the sorted sets, and non-duplicate transition destination(s) into a memory in the sorted order to reduce information amount of said state transition table;
(d) when one state and one input of the plurality of states and the plurality of inputs are given, referencing the memory to retrieve said non-duplicate transition destination(s) and lower-limit value or upper-limit value of one or more sets corresponding to the state, and comparing the retrieved lower-limit value or upper-limit value with the input value to identify a set, to which the given input belongs, based on the comparison result; and
(e) retrieving a transition destination corresponding to the identified set from among said non-duplicate transition destinations for determining the transition destination as a next state.
